(19) United States
(12) Patent Application Publication
(10) Pub. No.: US 2026/0222505 A1
(43) Pub. Date: Jul. 30, 2026

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: SHUNSUKE OTAWA, Kanagawa (JP)

(21) Appl. No.: 19/425,735

(22) Filed: Dec. 18, 2025

(30) Foreign Application Priority Data
Jan. 29, 2025 (JP) 2025-012768

(51) Int. Cl. H04N 1/00; G06V 10/70; G06V 30/19; G06V 30/262; G06V 30/414

(52) U.S. Cl. CPC H04N 1/00824; G06V 10/768; G06V 30/19; G06V 30/262; G06V 30/414

(57) ABSTRACT

A first scanned image corresponding to a first document to be a target of filing and a second scanned image corresponding to a second document on which filing is already performed are obtained, and also property information of the second scanned image that is generated by using a character string corresponding to a predetermined item of the second document is obtained. Next, property information of the first scanned image is generated by using a character string extracted from the first scanned image based on information indicating an attribute of the predetermined item. In addition, the information indicating the attribute of the predetermined item is obtained by estimation processing based on the second scanned image and a character string included in the property information of the second scanned image.

### BACKGROUND

### Field of the Technology

The present disclosure relates to a technique to extract a character string corresponding to a predetermined item from a document image.

### Description of the Related Art

Conventionally, there is a system that extracts a character string (in the following, called “idx character string”) corresponding to a predetermined item such as, for example, title, document number, issue date, company name, and amount from a scanned image obtained by scanning a paper document such as a business form by an image reading apparatus. In the system as described above, in order to correctly extract a desired idx character string from the scanned image, a user needs to designate contents of an item (item attribute) that the idx character string as an extraction target represents, by using a UI. In this context, there is a technique to precisely extract the idx character string from a document with a fixed layout (typical document) by setting an area-based extraction rule, which defines an area in the scanned image from which the idx character string is extracted, for each document type in advance. Additionally, there is a technique to create an extraction rule for a document with an unfixed layout (atypical document) based on an extraction target area designated by the user and a character area (item name candidate area) including an extracted term near the extraction target area (Japanese Patent Laid-Open No. 2019-49823).

In a case of the method of Japanese Patent Laid-Open No. 2019-49823, every time, it is necessary for the user to create in advance a proper extraction rule corresponding to the processing target document with the understanding of the contents of the document, and it is a great burden on the user. Additionally, a scene to which the method of Japanese Patent Laid-Open No. 2019-49823 is applicable is limited because the extraction rule using a key character string cannot be created in a case of the document including no key character string, for example.

### SUMMARY

An information processing apparatus according to the present disclosure, which is configured to generate property information of a scanned image of a document, includes: at least one memory that stores a program; and at least one processor that executes the program to perform: obtaining a first scanned image corresponding to a first document on which filing is to be performed and a second scanned image corresponding to a second document on which filing is already performed; obtaining property information of the second scanned image that is generated by using a character string corresponding to a predetermined item of the second document; and generating property information of the first scanned image by using a character string extracted from the first scanned image based on information indicating an attribute of the predetermined item, in which the information indicating the attribute of the predetermined item is information obtained by estimation processing based on the second scanned image and a character string included in the property information of the second scanned image.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an overall configuration of a system;

FIG. 2 is a diagram illustrating a hardware configuration example of an image formation apparatus;

FIG. 3 is a diagram illustrating a functional configuration example of the image formation apparatus;

FIG. 4 is a flowchart illustrating a flow of filing of a document;

FIG. 5 is a flowchart illustrating details of idx character string extraction processing;

FIG. 6A and FIG. 6B are diagrams describing block selection;

FIG. 7 is a diagram illustrating an example of a result of performing estimation of a document type and an extraction target item;

FIG. 8A is a diagram illustrating an example of a UI screen to set property information;

FIG. 8B is a diagram illustrating an example of the UI screen to set the property information;

FIG. 8C is a diagram illustrating an example of the UI screen to set the property information;

FIG. 8D is a diagram illustrating an example of the UI screen to set the property information;

FIG. 9 is a flowchart illustrating details of attribute estimation processing of the extraction target item;

FIG. 10 is a diagram illustrating an example of a scanned image of the document; and

FIG. 11 is a flowchart illustrating details of item attribute estimation processing according to a modification.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically.

### First Embodiment

### <System Configuration>

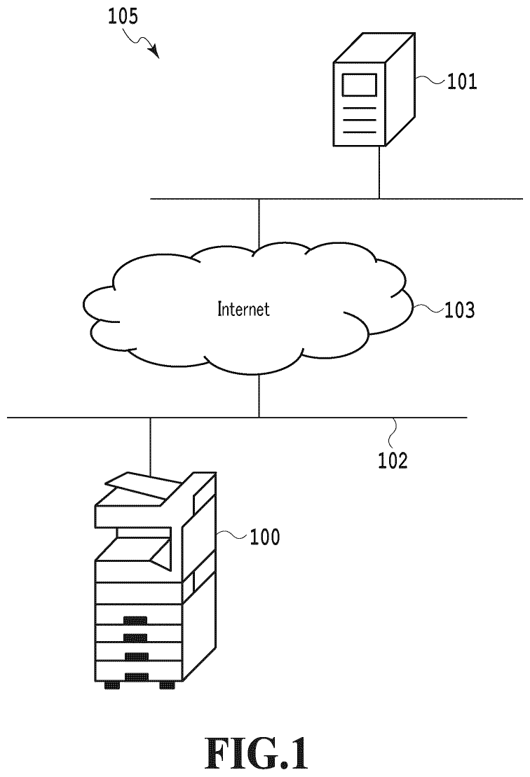

FIG. 1 is a diagram illustrating an overall configuration of a system to which the present embodiment is applicable. A system 105 of the present embodiment includes an image formation apparatus 100 and a terminal 101, both of which are information processing apparatuses. As illustrated in FIG. 1, the image formation apparatus 100 is connected to a LAN 102 and is communicable with the terminal 101, such as a PC, via the Internet 103 or the like. The image formation apparatus 100 is a multi function peripheral (MFP) that is a single device combining functions of copying, facsimiling, printing, scanning, and so on. Note that, in the present embodiment, the terminal 101 may be unnecessary, and a configuration including only the image formation apparatus 100 may be applicable. Additionally, in the present embodiment, as for each processing described later that is described to be performed by the image formation apparatus 100, a part of or all of the processing may be implemented by an external image processing apparatus (for example, a cloud server connected via the Internet).

### <Hardware Configuration of Image Formation Apparatus>

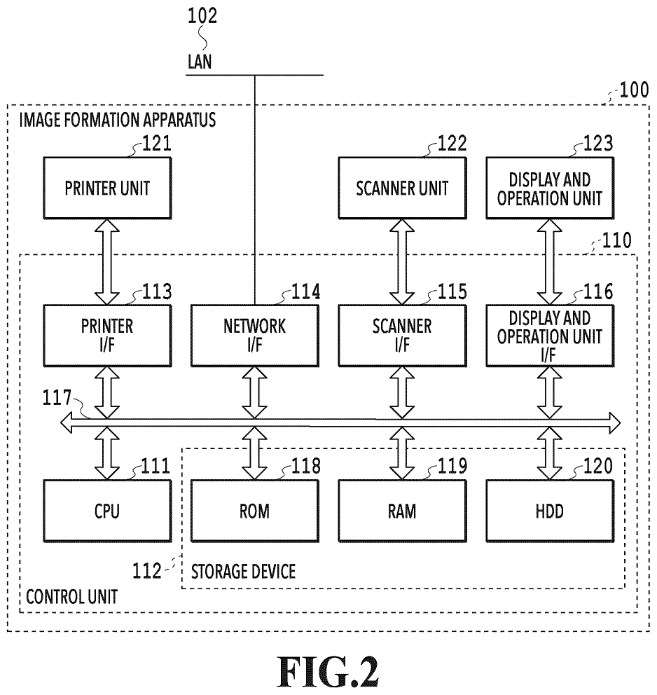

FIG. 2 is a block diagram illustrating a hardware configuration of the image formation apparatus 100. The image formation apparatus 100 of the present embodiment includes a control unit 110, a printer unit 121, a scanner unit 122, and a display and operation unit 123.

The control unit 110 includes a CPU 111, a storage device 112 (a ROM 118, a RAM 119, and an HDD 120), a printer I/F 113, a network I/F 114, a scanner I/F 115, and a display and operation unit I/F 116. Additionally, the units in the control unit 110 are communicably connected to each other via a system bus 117. The control unit 110 controls operations of overall the image formation apparatus 100.

The CPU 111 reads and executes a control program stored in the storage device 112 and implements reading control, image processing, printing control, display control, communication control, and the like in the flowcharts described later.

The storage device 112 stores and holds the control program, image data, metadata, setting data, processing result data, and the like. The storage device 112 includes the ROM 118 that is a non-volatile memory, the RAM 119 that is a volatile memory, the HDD 120 that is a high-capacity storage area, and so on. The ROM 118 is a non-volatile memory holding the control program and the like, and the CPU 111 reads the control program and performs control. The RAM 119 is a volatile memory used as a main memory of the CPU 111 and a temporal storage area such as a working area.

The network I/F 114 connects the control unit 110 (the image formation apparatus 100) to the LAN 102 via the system bus 117. The network I/F 114 transmits the image data to an external apparatus on the LAN 102 and receives various types of information from the external apparatus on the LAN 102.

The scanner I/F 115 connects the scanner unit 122 to the control unit 110 via the system bus 117. The scanner unit 122 generates the image data (scanned image data) by optically reading a document and inputs the scanned image data to the control unit 110 via the scanner I/F 115. Note that, the scanner unit 122 includes a document feeder and can feed multiple documents placed on a tray one by one and read the documents sequentially.

The display and operation unit I/F 116 connects the display and operation unit 123 to the control unit 110 via the system bus 117. The display and operation unit 123 displays a presentation result of a file name and a storage destination and displays a user interface to receive an instruction from a user. The display and operation unit 123 includes a liquid crystal display unit having a touch panel function, a hardware button, and the like.

The printer I/F 113 connects the printer unit 121 to the control unit 110 via the system bus 117. The printer unit 121 receives the image data generated by the CPU 111 via the printer I/F 113, and print processing on print paper is performed by using the received image data.

### <Functional Configuration of Image Formation Apparatus>

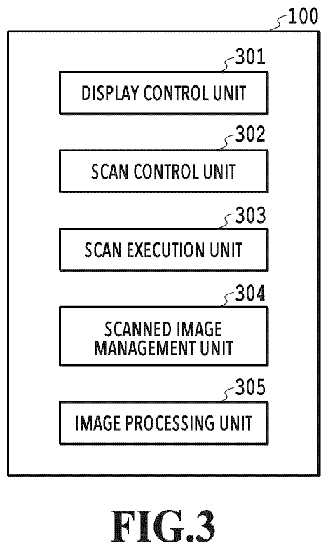

FIG. 3 is a block diagram illustrating a functional configuration (software configuration) of the image formation apparatus 100. Note that, FIG. 3 illustrates some of the functions of the image formation apparatus 100 that are narrowed down to the functions related to processing from scanning and digitalizing (filing) the document to saving the document.

A display control unit 301 displays a user interface screen (UI screen) to receive various user operations on the touch panel of the display and operation unit 123. The various user operations include, for example, scan setting, scan start instruction, correction instruction of extracted character string, file name setting, file saving instruction, and the like.

A scan control unit 302 instructs a scan execution unit 303 to execute scan processing according to the user operation received on the UI screen (for example, pressing a “scan start” button). In a case of the instruction to execute the scan processing, information on the scan setting is provided together. According to the instruction to execute the scan processing from the scan control unit 302, the scan execution unit 303 causes the scanner unit 122 to execute the reading operation of the document via the scanner I/F 115 and generates the scanned image data. The generated scanned image data is saved in the HDD 120 by a scanned image management unit 304.

An image processing unit 305 performs processing on the scanned image data, which is image analysis processing such as block selection processing, OCR processing (character recognition processing), and determination processing of similar documents, as well as image processing such as rotation and inclination correction. With the image processing unit 305, the image formation apparatus 100 also functions as an image processing apparatus. Note that, details of the image processing by the image processing unit 305 are described later.

The function of each unit in FIG. 3 is implemented with the CPU of the image formation apparatus 100 deploying the program code stored in the ROM to the RAM to execute. Alternatively, a part of or all the functions of each unit in FIG. 3 may be implemented by hardware such as an ASIC and an electronic circuit.

### <Filing of Document>

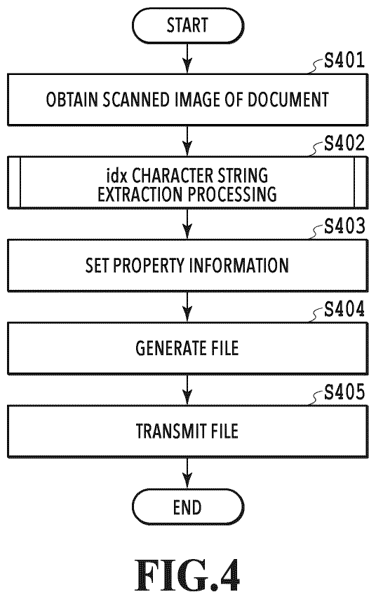

Subsequently, the filing of the document by the image formation apparatus 100 is described. In the filing of the document, a series of processing is performed, in which the document is read first, the image processing is performed on the scanned image of the first page of the document, the file name is generated by using the character string included in the scanned image, and the generated file name is presented to the user through the display and operation unit 123. FIG. 4 is a flowchart illustrating a flow of the filing of the document. In the following, detailed description is provided along the flowchart in FIG. 4. Note that, the series of processing illustrated in the flowchart in FIG. 4 is implemented with the CPU 111 deploying the program code stored in the ROM 118 to the RAM 119 to execute. In the following description, a symbol “S” means a step, and the same applies to the subsequent flowcharts.

In S401, once receiving a scan instruction from the user via the display and operation unit 123, the scan control unit 302 takes out the documents set on the document feeder of the scanner unit 122 one by one and causes the scan execution unit 303 to execute scanning. Note that, in the present embodiment, it is assumed that the document as a target of the scanning is a bill, an estimate form, and so on that are generally called a business form. In addition, the above-described business form includes a typical document with a fixed layout and an atypical document with an unfixed layout. Thus, the scan control unit 302 obtains the scanned image of the document.

In S402, the image processing unit 305 analyzes the scanned image obtained in S401 and performs processing to extract the character string corresponding to a predetermined item on the scanned document (in the following, called “idx character string”) based on target item information. In this case, the target item information is information indicating an attribute of the predetermined item as an extraction target. The extracted idx character string is used as the file name in a case of saving the scanned image. Details of the target item information and details of idx character string extraction processing based on the target item information are described later. Note that, an aspect of using the idx character string is not limited to generating the file name. For example, the idx character string may be used to apply metadata, to generate a folder path, and also to generate data derived from an image file such as a CSV file in which item values in the document are comma-delimited. That is, “property information” in the present specification is a concept containing various data generated in regard to the scanned image of the document.

In S403, the display control unit 301 performs setting of the property information based on the idx character string extracted in S402 (extracted character string). Specifically, the UI screen (confirmation and correction screen) including the extracted idx character string and the file name automatically generated based on a use rule of the idx character string is displayed to be presented to the user, and an input operation of confirmation or correction by the user regarding the presented file name is received. In this case, the use rule in a case of generating the file name includes the target item information and a file naming rule. The target item information is the information indicating the attribute of the item as the extraction target that is provided in the form of “item attribute: <title>, <distributing company name>, <billing number>, <billing date>,” for example. In this case, “<” and “>” sandwiching the character string mean that the corresponding character string is predefined. The file naming rule defines how to generate the file name by using the idx character string of the item identified by the target item information and is provided in the form of “file name: <title>_<distributing company name>_<billing number>.pdf,” for example. In a case of this example, it is indicated that the file name is generated by connecting the character string corresponding to <title>, the character string corresponding to <distributing company name>, and the character string corresponding to <billing number> in this order by an underscore as a separator. Note that, in a case where no target item information exists or a case where the extraction of the idx character string fails, the display control unit 301 displays a UI screen to prompt input of the character string to be set as the file name instead of the above-described confirmation and correction screen and receives the input operation of the user. Based on the input operation by the user via the UI screen as described above, the presented (or corrected) file name is determined as the file name of the scanned image. Details of property information setting processing are described later.

In S404, the image processing unit 305 performs the filing of the scanned image obtained in S401 by using the property information (file name) set in S403. In the present embodiment, as an example, it is described that the filing of the scanned image is performed in the form of Portable Document Format (PDF). In a case of PDF, it is possible to save the image data by page units, and in a case where multiple documents are scanned in S401, the scanned images corresponding to the documents are each saved as individual pages in a single file.

In S405, the scanned image management unit 304 transmits the file generated in S404 to a predetermined transmission destination through the LAN 102.

The above is a rough flow of the filing of the document by the image formation apparatus 100. Note that, although it is described assuming that the processing is performed by the image formation apparatus 100 by itself, a part of the processing may be performed by another apparatus. For example, the scan processing of the document is executed by the image formation apparatus 100, and the obtained scanned image is transmitted to the terminal 101 via a network. The terminal 101 may include a function unit similar to that of the image processing unit 305, and the idx character string extraction processing may be executed by the terminal 101. In this case, the terminal 101 may reply an extraction result of the idx character string to the image formation apparatus 100, and the image formation apparatus 100 may perform file generation and file transmission based on the obtained extraction result of the idx character string.

### <Idx Character String Extraction Processing>

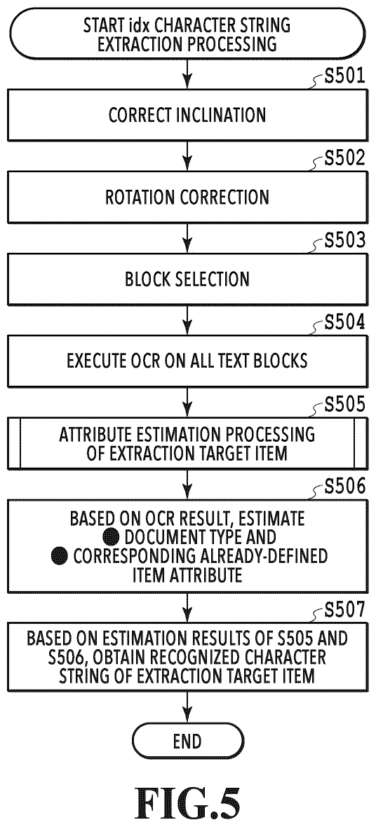

Subsequently, the idx character string extraction processing performed by the image processing unit 305 in S402 described above is described. FIG. 5 is a flowchart illustrating details of the idx character string extraction processing. In the following, detailed description is provided along the flowchart in FIG. 5.

In S501, processing of correcting inclination is performed on the scanned image of the page of interest as the processing target. Specifically, first, detection of the inclination (angle) of the scanned image is performed, and processing of rotating the scanned image of interest by the detected inclination in the opposite direction is performed. The inclination of the scanned image occurs because the document cannot be read straight due to abrasion of a roller and the like in the document feeder of the scanner unit 122 during scanning of the document, for example. Alternatively, the inclination occurs because the scanned document is not printed straight during printing. A method of detecting the inclination is as follows. First of all, an object included in the scanned image is detected, and object groups adjacent to each other in a horizontal direction or a vertical direction are coupled. Then, an angle of a connection between the center positions of the coupled object groups to the horizontal direction or the vertical direction is derived, and thus the inclination is obtained. Note that, the method of detecting the inclination is not limited to the above method. In addition, for example, a center coordinate of the object included in the scanned image may be obtained, center coordinate groups may be rotated by the unit of 0.1 degrees, and an angle at which the center coordinate groups are most likely arrayed in the horizontal direction or a perpendicular direction may be obtained as the inclination of the scanned image. The correction of the inclination of the scanned image makes it possible to increase an accuracy in each processing performed subsequently, such as rotation correction, block selection, and OCR.

In S502, orientation correction in which the image is rotated by the unit of 90 degrees is performed on the scanned image after the inclination correction such that the character in the image is in an upright orientation. A method of the orientation correction is as follows. First of all, using the scanned image after the inclination correction as a reference image, an image obtained by rotating the reference image 90 degrees, an image obtained by rotating the reference image 180 degrees, and an image obtained by rotating the reference image 270 degrees are additionally prepared. Then, simple OCR that can be processed at high speed is executed on each of the four prepared images, and the image including the greatest number of characters that are recognized with a certainty equal to or greater than a certain value is selected as the image after the rotation correction. Note that, the method of the rotation correction is not limited to the above method. Note that, in the following description, “scanned image” indicates the scanned image after the inclination and the orientation are corrected unless otherwise stated.

In S503, the block selection is performed on the scanned image. Block selection is processing of detecting the text block by categorizing the scanned image into a foreground area and a background area and then separating the foreground area into a character string area (text block) including the character string and an area other than the character string area. A method of the block selection is as follows. First of all, contour tracking is performed on the scanned image binarized into white and black, and a block of pixels surrounded by a black pixel contour is extracted. Then, in the block of the black pixels having an area greater than a predetermined size, contour tracking is also performed on a white pixel inside the block of the black pixels to extract a block of white pixels, and additionally, the block of the black pixels is extracted recursively from the inside of the block of the white pixels having an area equal to or greater than a certain size. The block of the black pixels obtained as described above is determined as the foreground area. Then, the determined foreground area is categorized as an area of the respective object attribute based on the size and the shape. For example, the foreground area of an aspect ratio close to “1” and the size within a certain range is determined as the pixel block corresponding to a character, and an area in which close characters may be grouped in good alignment is determined as the character string area (TEXT attribute). A flat pixel block is determined as a line area (LINE attribute). A range of a certain size or greater that is occupied by the black pixel block containing the white pixel blocks in good alignment is determined as a table area (TABLE attribute). An area including dispersed irregular pixel blocks is determined as a photograph area (PHOTO attribute). In addition, the pixel block having a shape other than the above is determined as a picture area (PICTURE attribute). Thus, from the areas divided for each object attribute, the foreground area determined to have the TEXT attribute is detected as “character string area (text block).”

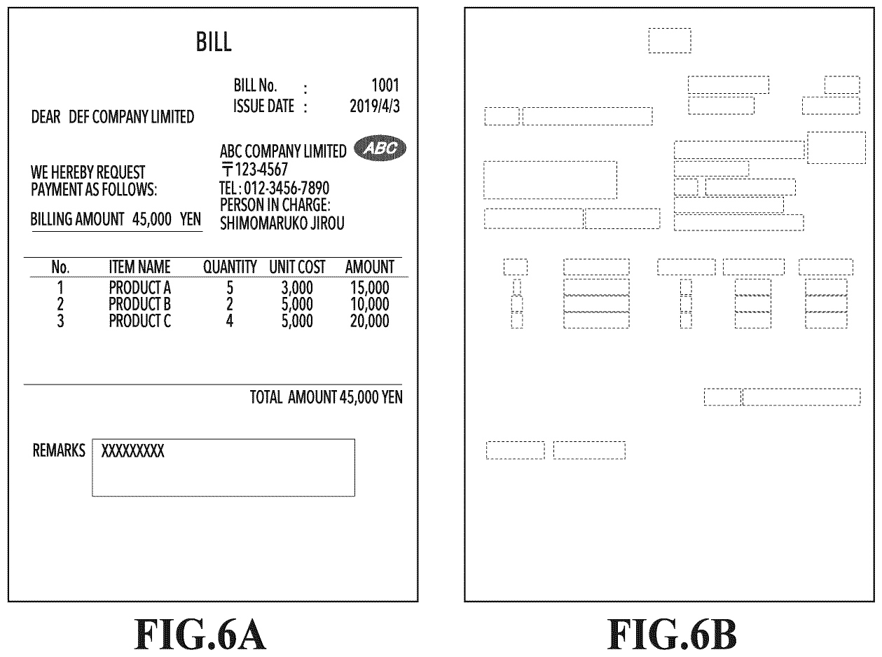

FIG. 6A and FIG. 6B are diagrams describing the block selection. FIG. 6A illustrates the scanned image, and FIG. 6B illustrates a result of the block selection performed on the scanned image in FIG. 6A. In FIG. 6B, a rectangle illustrated with a dotted line represents the text block. Information of each text block detected in the present step (information indicating the object attribute and position and size of the block) is used for the subsequent OCR, similarity calculation, and so on. Note that, the reason of detecting only the text block during the block selection in the present step is because the position of the character string expresses the structure of the scanned image well and is closely related to the extraction rule of the character string corresponding to the predetermined item. Accordingly, it does not mean to preclude the use of the information of the block determined to have another object attribute, such as the photograph area and the table area, in the subsequent processing.

In S504, the OCR processing (whole-area OCR processing) for all the text blocks detected in S503 is executed, and the recognized character string corresponding to each text block is obtained.

In S505, the character string that is used for the file name and the like is obtained from a reference scanned image on which the filing is performed in the past, and based on the obtained character string, processing to estimate the attribute of the extraction target item is executed. The information of the item attribute estimated by the processing is used in S507 performed later as the information identifying the extraction target item (target item information). Details of the estimation processing in the present step are described later.

In S506, based on the recognized character string obtained by the whole-area OCR in S504, estimation of the document type of the inputted document and a corresponding already-defined item attribute is performed. In this case, the already-defined item attribute means the predefined item attribute. The item attribute that is not predefined is an undefined item attribute. For example, rule-based estimation is applied to the estimation in the present step. The rule-based estimation is an estimation method using a rule determined advance based on the position of the object and a font size in the document, a format of the character string, whether there is a particular key character string, positional relationship between the key character string and another character string, and the like. In the following, the estimation of the document type and the estimation of the corresponding already-defined item attribute are described separately.

### <<Estimation of Document Type>>

It is possible to estimate the document type of the inputted document (use application of the document) according to the particular key character string existing in the inputted document, for example. For example, in a case where the key character strings such as “billing,” “estimate,” “order,” and “delivery” exist in the inputted document, the inputted documents are estimated as “bill,” “estimate form,” “order form,” and “delivery slip” as the document type, respectively. In this process, for example, in some cases, the character strings of both “delivery” and “billing” exist in the inputted document. In this case, it may be considered as failing the estimation of the document type, or different degrees of priority may be provided to the key character strings based on the position, the size, the number of times of appearance, and the like of the text block to estimate the document type. Additionally, the document type, like “delivery slip and bill,” may be defined as the document that has multiple use applications.

### <<Estimation of Corresponding Already-Defined Item Attribute>>

The estimation of the corresponding already-defined item attribute can be paraphrased as processing of discriminating whether all the recognized character strings obtained by the whole-area OCR correspond to the character string of any one of the already-defined item attributes. As described above, the already-defined item attribute is formed of an abstract item attribute and a detailed item attribute corresponding to each abstract item attribute. The “abstract item attribute” means the item attribute common for various document types independent of the document type, and the “detailed item attribute” means the item attribute obtained by materializing the abstract item attribute according to the document type. In the following Table 1, a list of an example of the already-defined item attributes is illustrated.

TABLE 1

| | document type | | | |
|---|---|---|---|---|
| abstract item | | estimate | | delivery |
| attribute | bill | form | order form | slip |
| title | — | — | — | — |
| issue date | billing date | estimate | order date | shipping |
| | | date | | date |
| document number | billing | estimate | order | delivery |
| | number | number | number | number |
| issuing company | distributing | distributing | purchasing | distributing |
| name | company | company | company | company |
| total amount | billing | estimate | order | billing |
| | amount | amount | amount | amount |

In Table 1 mentioned above, for example, in <issue date> as the abstract item attribute, <billing date>, <estimate date>, <order date>, and <shipping date> are defined in association with the document type as the detailed item attribute of the abstract item attribute. There is no detailed item attribute exists in <title> as the abstract item attribute because <title> is the item attribute independent of the document type. For example, in addition to that indicated in Table 1 mentioned above, various abstract item attributes may be defined according to the use application such as <human name>, <address>, <zip code>, <payment method>, and <due date>. In a case of each abstract item attribute indicated in Table 1 mentioned above, it is possible to perform the estimation as follows.
Estimate the character string as <title> that is positioned in an upper portion of the document and has a large font size.
Estimate the character string as <issue date> that is positioned around the key character string such as “date” and “issue date” or in an upper right portion of the document and that matches a format such as yyyy-mm-dd.
Estimate the character string as <document number> that includes a number such as “T-1234” around the key character string such as “number,” “No.,” and “#” or that includes a number that does not match the format such as yyyy-mm-dd positioned in the upper right portion of the document.
Estimate the character string as <issuing company name> that is positioned in the upper right portion of the document, not positioned around the key character string “Dear,” and positioned around the key character string such as “company,” and “Inc.,” and has a similar height of the text block as that of those key character strings.
Estimate the character string as <total amount> that is positioned around the key character string such as “total” and “billing” and is a number string including a currency symbol and a digit separator symbol adjacent to the key character string that is a unit of currency, or a number string in the lowest right portion in a case where multiple number strings are arranged by integral multiples at certain intervals in the perpendicular direction.

Note that, in some cases, the estimation result includes an error. For example, in some cases, the character string “2019 Apr. 3” indicating <document number> is improperly estimated to correspond to the character string of <issue date>.

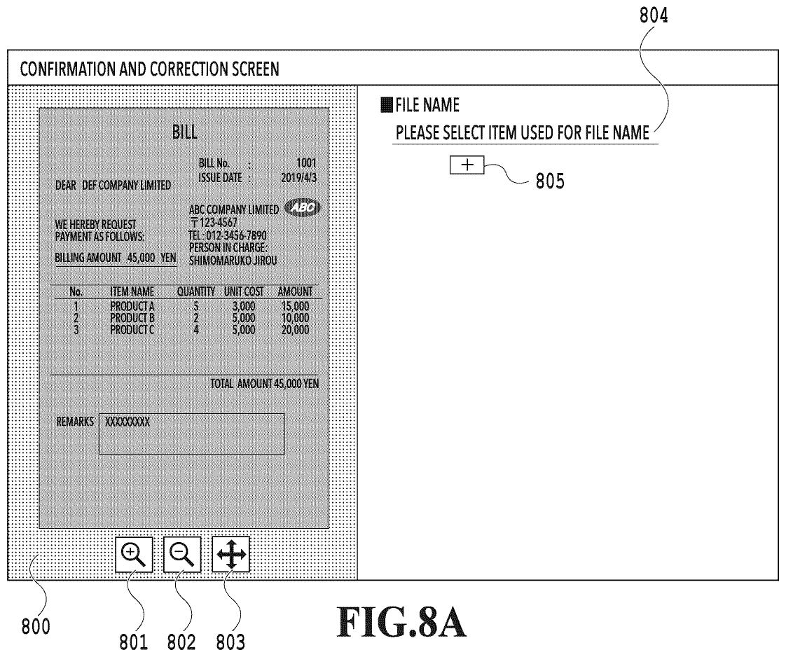

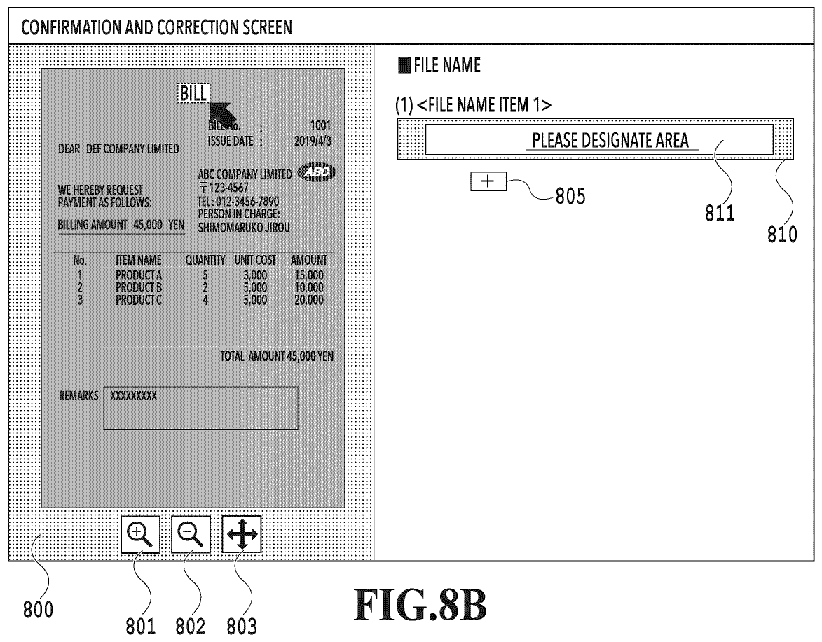

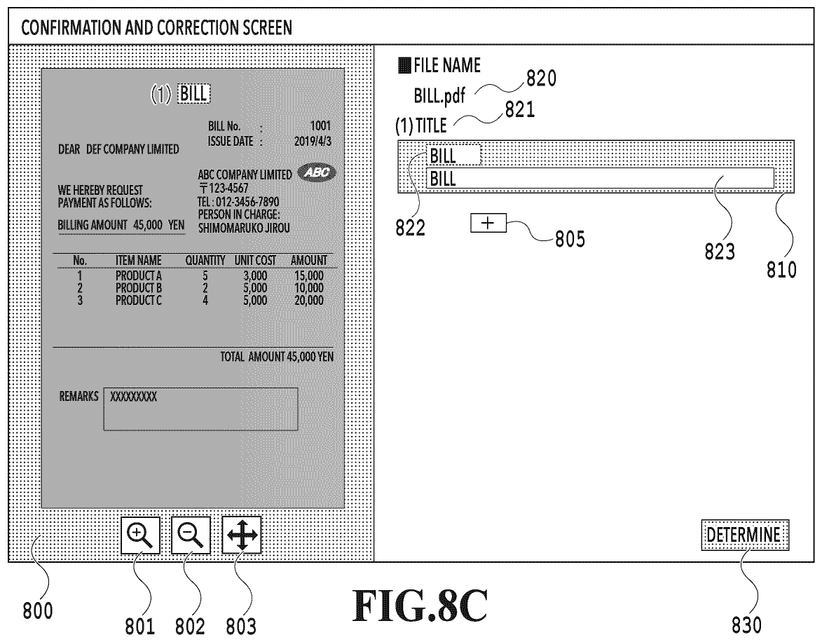

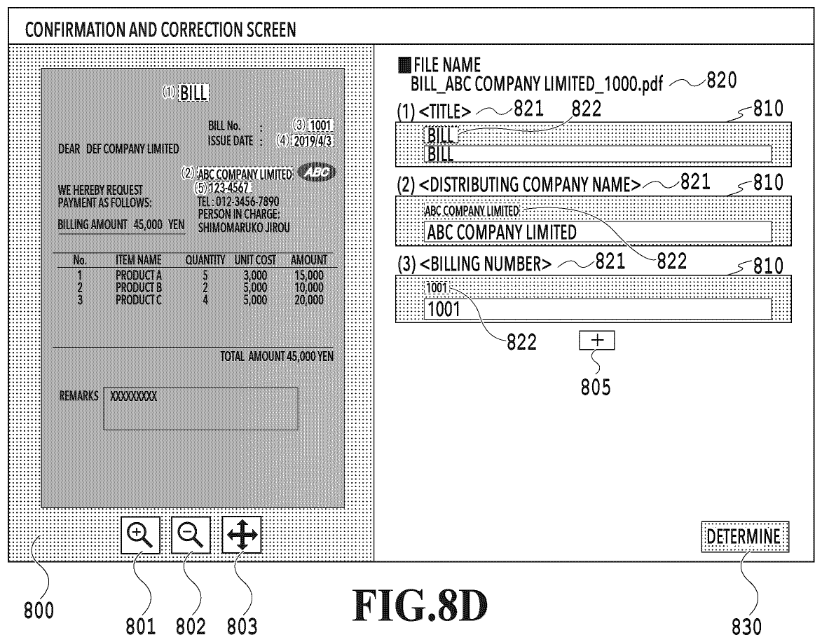

As described above, once the estimation of the abstract item attribute ends, subsequently, the estimation of the detailed item attribute is performed. The estimation of the detailed item attribute is performed based on an estimation result of the document type and an estimation result of the abstract item attribute. For example, in a case where the estimation result of the document type is “bill,” and the estimation result of the abstract item attribute is <issue date>, it is estimated that the detailed item attribute corresponding to <issue date> of the bill is <billing date>. Thus, the recognized character string estimated to correspond to the detailed item attribute and the position thereof are identified. Note that, in a case where the document type cannot be estimated, or as for the abstract item attribute for which no detailed item attribute is defined like <title>, the recognized character string estimated to correspond to the abstract item attribute and the position thereof are identified. FIG. 8 is a diagram illustrating an example of a result of performing the estimation of the document type and the extraction target item on the scanned image in FIG. 6A. In this example, first, based on the recognized character string “billing,” the document type is estimated as “bill.” In addition, it is estimated that the recognized character string “bill” corresponds to the abstract item attribute <title>. Additionally, it is estimated that the recognized character string “1001” corresponds to the abstract item attribute <billing number>. Moreover, it is estimated that the recognized character string “2019 Apr. 3” corresponds to the abstract item attribute <billing date>. Furthermore, it is estimated that the recognized character string “ABC company limited” corresponds to the abstract item attribute <distributing company name>. In addition, it is estimated that the two recognized character strings “45,000” correspond to the abstract item attribute <billing amount>.

Note that, the estimation method in the present step is not limited to the rule-based estimation. For example, the estimation may be performed by using a large language model (LLM) that is a machine learning model learned in advance.

The LLM includes a Transformer model, a bidirectional LSTM, a Sequence2Sequence model, an RNN, and so on.

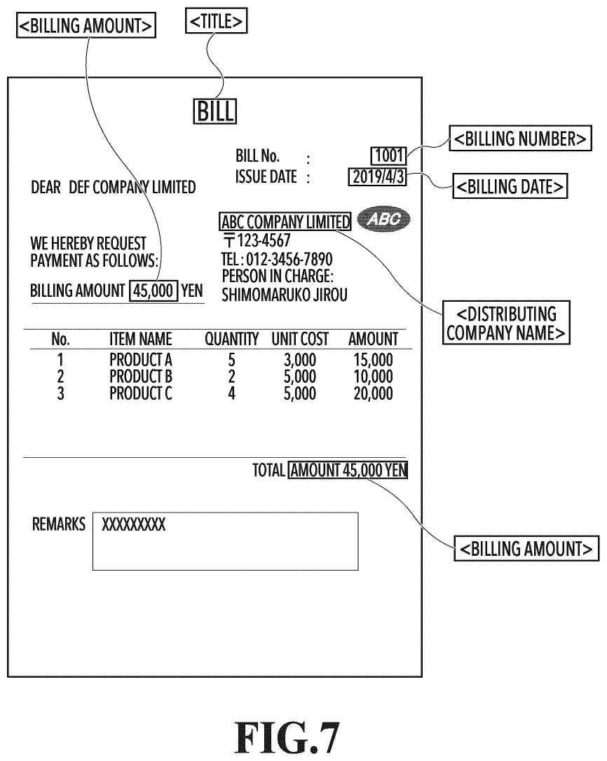

In S507, based on the estimation result in S505 and the estimation result in S506, the recognized character string corresponding to the extraction target item is obtained as the idx character string. Now, for example, it is assumed that the estimation result (target item information) like “item attribute: <title>, <distributing company name>, <billing number>” is obtained in the attribute estimation processing of the extraction target item in S505. In this case, from the scanned image in FIG. 7, the recognized character strings that are “bill” as <title>, “ABC company limited” as <distributing company name>, “1001” as <billing number>, and “2019 Apr. 3” as <billing date> are obtained as the idx character strings. Note that, in a case where there is no recognized character string corresponding to a certain extraction target item, the extraction target item is processed as an extraction failure.

The above is the contents of the idx character string extraction processing. Note that, in the estimation in S506, in some cases, a result that multiple recognized character strings corresponding to the same already-defined item attribute exist in the document is obtained. In this case, for example, the recognized character strings obtained by the whole-area OCR in S504 are listed in a predetermined order of being read, and the recognized character string at the top is obtained. Alternatively, for example, the certainty of the position of the extraction area (extraction position certainty) may be obtained from the matching degree with the rule used for the estimation, and the recognized character string with the highest extraction position certainty may be obtained as the idx character string. Additionally, the multiple recognized character strings may be obtained first, and in the subsequent property information setting processing (S403), one recognized character string to be adopted as the idx character string may be selected by the user from the multiple recognized character strings. Note that, although a series of the processing illustrated in the flow in FIG. 5 is all executed by the image processing unit 305 in the present embodiment, the above-described idx character string extraction processing may be implemented with the server on the Internet executing a part of the processing, and the image processing unit 305 using the result.

### <Processing of Setting Property Information>

Next, processing of setting the property information performed by the display control unit 301 in S403 described above is described in detail. FIG. 8A to FIG. 8D are examples of the UI screen (confirmation and correction screen) to confirm and correct the character string of the file name that is referred by the user to set the property information. In the following, description is provided using the specific examples of the UI screen.

FIG. 8A illustrates a state of the confirmation and correction screen in a case where there is no reference scanned image on hand, and the attribute estimation of the extraction target item in S505 cannot be performed, or a case where the obtainment of the idx character string in S507 fails. In a preview area 800 on a left side of the screen, the scanned image of the inputted document is displayed as a preview image. Buttons 801 and 802 are buttons to enlarge and contract a display magnification of the preview image. A button 803 is a button to enlarge or contract the preview image to be fitted with a width or a height of the preview area. In a case where the confirmation and correction screen in FIG. 8A is displayed, no extraction target item is identified, and thus no idx character string is extracted. For this reason, the automatic generation of the file name using the idx character string is not performed as well, and a message 804 prompting the user to select the item used for the file name is displayed in the position where a file name candidate is originally displayed. A button 805 displayed below the message 804 is a button to add the item used for the file name. The user presses the button 805 to designate the text block of the desired item to be used for the file name. In a case where the user presses the button 805 from the state in FIG. 8A, the confirmation and correction screen transitions to the state in FIG. 8B.

An idx character string field 810 is displayed on a right side of the confirmation and correction screen in FIG. 8B.

In addition, in the idx character string field 810, a button 811 to designate the text block corresponding to the desired item is displayed. The user presses the button 811 and designates the text block corresponding to the desired item in the preview image by using a mouse and the like. Now, in the example in FIG. 8B, the text block of “bill” on the preview image is designated and displayed with a highlight. Once the text block corresponding to the desired item is designated as described above, the confirmation and correction screen transitions from the state in FIG. 8B to the state in FIG. 8C. On the confirmation and correction screen in FIG. 8C, a tentative file name “bill.pdf” using the recognized character string of the designated text block “bill” is displayed in a file name field 820. In addition, the item attribute of the designated text block <title> is displayed in an item attribute field 821 below the file name field 820. Moreover, inside the idx character string field 810, a partial preview area 822 and an idx character string field 823 are displayed. In the partial preview area 822, a partial image corresponding to the designated text block is cut out from the scanned image and displayed. In the idx character string field 823, the recognized character string “bill” extracted as the idx character string is displayed. In a case where the recognized character string displayed in the idx character string field 823 is wrong, the user can edit directly. The determine button 830 is a button to press by user once completing the confirmation or the necessary correction for the file name.

FIG. 8D illustrates the confirmation and correction screen, after the user operations as described above are performed, in a case where the text block of the item used for the file name is designated, or in a case where the obtainment of the idx character string succeeds in S507. In the example in FIG. 8D, as the text block of the item used to generate the file name, the text blocks corresponding to the character strings “bill,” “ABC company limited,” and “1001,” respectively, are designated. Now, the designated text blocks are the text blocks of the “corresponding already-defined item attribute” estimated in S506. Therefore, the corresponding already-defined item attributes that are <title>, <distributing company name>, and <billing number> are displayed in the item attribute field 821. In addition, in each idx character string field 810, the partial image of the corresponding text block and the recognized character string extracted therefrom are displayed. Moreover, in the file name field 820, the file name generated by combining the extracted idx character strings (or the character strings edited by the user) according to the file naming rule (coupling the idx character strings by an underscore) is displayed. Note that, in a case where the text block designated by the user is not the text block of “corresponding already-defined item attribute” estimated in S506, the name of the default undefined item attribute automatically generated is displayed in the item attribute field 821. The name of the undefined item attribute can be edited by the user. Once completing the confirmation or the necessary correction for the file name, the user presses the determine button 830. With the determine button 830 being pressed, the item used for the file name and the corresponding text block are determined for the scanned image being displayed.

### <Attribute Estimation Processing of Extraction Target Item>

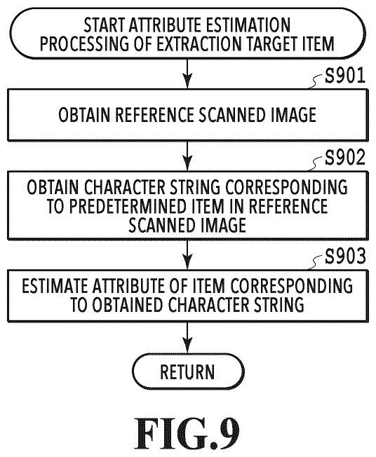

Next, the attribute estimation processing of the extraction target item (S505) that is a part of the above-described idx character string extract processing (S402) is described in detail. FIG. 9 is a flowchart illustrating details of the attribute estimation processing of the extraction target item. As described above, in this processing, the estimation of the attribute of the extraction target item is performed based on the character string corresponding to the extraction target item obtained from the scanned image of the document on which the filing is performed in the past. In the following, detailed description is provided along the flowchart in FIG. 9.

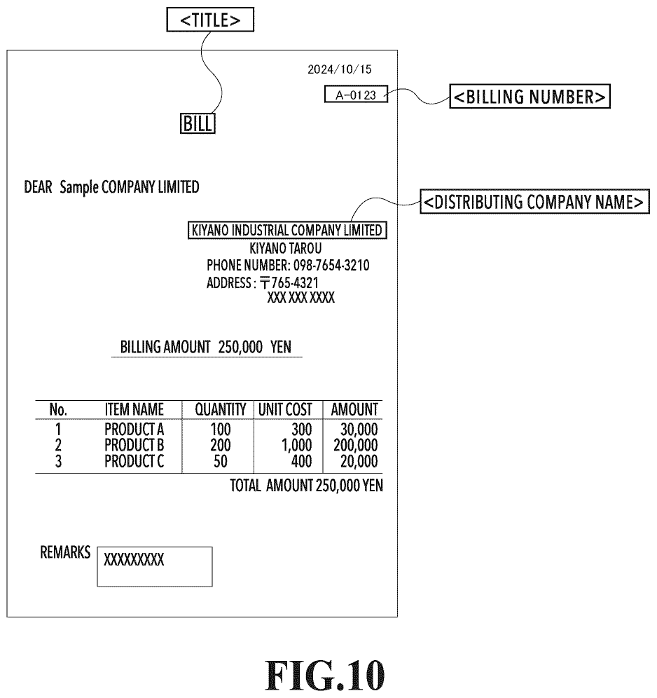

In S901, the reference scanned image that is the scanned image used for the attribute estimation of the extraction target item is obtained. FIG. 10 is a diagram illustrating an example of the reference scanned image obtained in the present step. For example, before the scanned image on which the filing is to be performed this time is obtained in S401, the designation of the reference scanned image is additionally received from the user via the display and operation unit 123 to save the image data thereof in the HDD 120 and the like, and the image data is read and obtained in the present step. Alternatively, after the scanned image on which the filing is to be performed this time is obtained in S401, in a timing for starting the processing in S505, the designation of the reference scanned image may be received and obtained from the user via the display and operation unit 123.

In S902, the character string corresponding to the item that is existing in the reference scanned image obtained in S901 and desired to be the extraction target is obtained. For example, the character string from the various character strings in the obtained reference scanned image that is used for the file name is obtained by applying the above-described file naming rule and rule-based estimation method. Now, the file naming rule is provided in the form of “file name: <title>_<distributing company name>_<billing number>.pdf.” In addition, “bill Kiyano Industrial Company Limited_A-0123.pdf” is applied to the reference scanned image in FIG. 10 as the file name. In this case, the file name of the reference scanned image is divided by “_” used as a separator in the above-described file naming rule, and thus three character strings that are “bill,” “Kiyano Industrial Company Limited,” and “A-0123” can be obtained. Note that, the character string corresponding to the predetermined item may be obtained from the property information other than the file name of the reference scanned image. For example, another file (for example, text file, CSV file, Excel file, or the like) in which the above-described three character strings are written may be received simultaneously with the reference scanned image data, and the character strings may be extracted by analyzing the other file. Additionally, the character strings may be obtained by directly inputting to the character string corresponding to the predetermined item by the user via the display and operation unit 123.

In S903, the estimation of the correspondence between each of one or more character strings obtained in S902 and the meaning of the item in the reference scanned image obtained in S901 (estimation of item attribute) is performed by the unit of character string. Specifically, first, the block selection and the whole-area OCR are performed on the reference scanned image (see S503 and S504 described above), and a text block group and the recognized character string for each text block is obtained. Next, from the text block group obtained by the block selection, the text block of the recognized character string matching the character string obtained in S902 is identified. Now, in the reference scanned image in FIG. 10, the three character strings that are “bill,” “Kiyano Industrial Company Limited,” and “A-0123” are obtained, and the text block corresponding to each of the above-described three character strings is identified based on the OCR result. Next, the attribute of the item corresponding to the recognized character string is estimated for each identified text block. As with S506 described above, a rule-based method and a method using the machine learning model may be applied to the estimation of the item attribute in this case. In other words, in the rule-based method, the item attribute of the identified text block is estimated based on the position and the font size in the reference scanned image, positional relationship with another character string, and the like. In the example of the reference scanned image in FIG. 10, each item attribute of <title>, <distributing company name>, and <billing number> is estimated from each text block of “bill,” “Kiyano Industrial Company Limited,” and “A-0123.” The information of the item attribute estimated as described above is used to obtain the idx character string in S507 described above as “target item information” indicating the attribute of the predetermined item as the extraction target. The target item information is provided in the form of “item attribute: <title>, <distributing company name>, <billing number>,” for example.

The above is the contents of the attribute estimation processing of the extraction target item. Although the attribute estimation processing of the extraction target item is executed as a part of the flow in FIG. 4 in the present embodiment, the execution timing is not limited thereto. For example, only the flow in FIG. 5 may be independently performed in advance, the obtained target item information may be held in the HDD 120 and the like, and in the idx character string extract processing (S402) in the flow in FIG. 4 that is executed thereafter, the target item information being held may be read and obtained.

Note that, as for the certain character string obtained in S902, in some cases, there are multiple corresponding text blocks existing in the image. In this case, there is a possibility that the multiple text blocks corresponding to the character string are identified in S903, and the item attributes of different contents are estimated from the corresponding multiple text blocks. In this case, it is difficult to know which item attribute to be used as the attribute of the extraction target item to extract the idx character string. Therefore, in this case, the text blocks may be prioritized based on the appearance order of the identified multiple text blocks in the image, and the item attribute may be estimated from one text block that has the highest priority. Alternatively, the item attribute may be estimated from each of the multiple text blocks, and the target item information based on the result may be presented to the user so as to allow the user to select and correct the target item information.

Additionally, in some cases, multiple item attributes can be estimated from one text block identified for the certain character string in S903. In this case, for example, from the text block identified for the character string “20230401,” both <billing date> and <billing number> may be obtained as the estimation item attribute. In a case where it is possible to estimate the multiple item attributes based on one text block as described above, it is difficult to know which item attribute to adopt to extract the idx character string. Therefore, in this case, the item attributes may be prioritized in advance, and the item attribute that has a higher priority may be adopted. Alternatively, the target item information based on the multiple estimated item attributes may be presented to the user so as to allow the user to select and correct the target item information.

### Modification Example

Depending on the inputted reference scanned image, there is a case where only the abstract item attribute such as <issue date> can be estimated, for example. In this case, for example, in a case of the scanned image of the document including multiple dates of the billing date, the estimate date, the order date, and the delivery date, it is difficult to know which character string of the item to extract. Therefore, in a case where only the abstract item attribute can be estimated from the inputted reference scanned image, the reference scanned image may be additionally obtained.

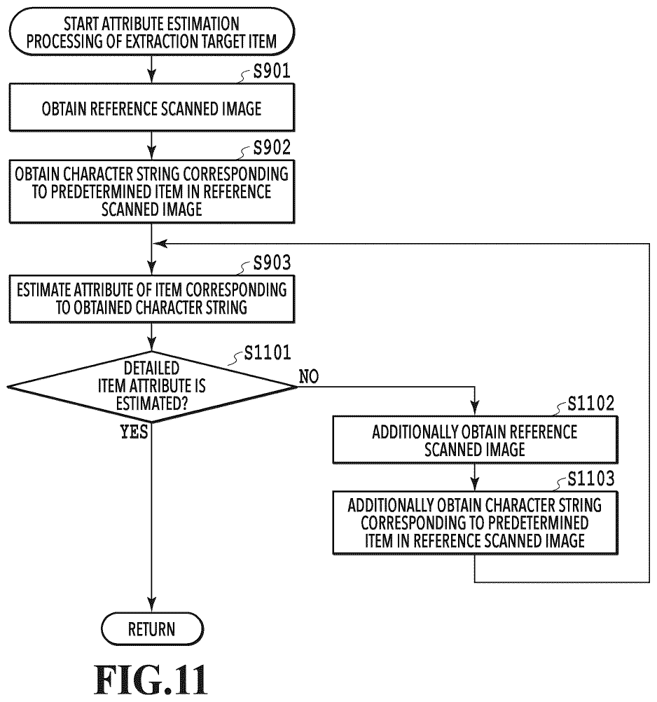

FIG. 11 is a flowchart illustrating details of the attribute estimation processing of the extraction target item (S505) according to the present modification. A difference from the flow in FIG. 9 is that S1101 to S1103 are added. In the following, description is provided along the flow in FIG. 11.

S901 to S903 are the same as S901 to S903 in the flow in FIG. 9 described above; for this reason, the description is omitted. In S1101, whether the estimation of the detailed item attribute regarding each item attribute estimated in S903 succeeds in a case where the detailed item attribute exists is determined. For example, since <title> is the abstract item attribute independent of the document type, and there is no detailed item attribute, it is not the target of the determination in the present step. In a case where the estimation of the detailed item attribute succeeds for each estimated item attribute, the processing ends. On the other hand, in a case where the estimation of the detailed item attribute fails for any one of the estimated item attributes, the processing proceeds to S1102.

In S1102, the additional reference scanned image to be used for the estimation of the item attribute is obtained. Specifically, a message prompting the user to input the reference scanned image of another document including the character string of the desired item is displayed via the display and operation unit 123 for example, and the reference scanned image is additionally obtained by the method similar to S901. In the subsequent S1103, as with S902, the character string corresponding to the item that is written in the reference scanned image additionally obtained in S1102 and desired to be the extraction target is obtained. Once the character string corresponding to the item that is desired to be the extraction target is obtained in S1103, the processing returns to S903, and the estimation of the item attribute is performed. In other words, the estimation of the correspondence between each of one or more character strings obtained from the additional reference scanned image and the meaning of the item in the corresponding reference scanned image (estimation of the item attribute) is performed by the unit of character string. It is possible to determine more proper extraction target item by the above-described processing.

As described above, according to the present embodiment, with the user only designating the character string corresponding to the predetermined item desired to be extracted based on the scanned image on which the filing is performed in the past, it is possible to easily extract the character string corresponding to the predetermined item in a case of filing a new scanned image.

### Second Embodiment

For example, since the zip code is not included as the already-defined item attribute in Table 1 mentioned above, in the method in the embodiment 1, it is impossible to set the character string representing the zip code as the extraction target item even in a case where the reference scanned image includes the character string representing the zip code. Therefore, an aspect in which various item attributes are estimated by the text generation model regardless of whether it is predefined is described as an embodiment 2. Note that, since the system configuration and the flow of the filing of the document are common to the embodiment 1, in the following, the method of estimating the item attribute, which is a different point from the embodiment 1, is mainly described.

### <Text Generation Model>

The text generation model is a machine learning model that is obtained by learning using a great amount of text data and is a model generating a new text based on provided input data. Recent years, the text generation model has been used in various fields of text generation, translation, summarization, dialogue system, and the like. The text generation model includes a Transformer model and the like, for example. As a learning method, there are supervised learning and self-supervised learning. In the supervised learning, a learning model is trained by using a pair of text data prepared in advance and corresponding correct data. On the other hand, in the self-supervised learning, training proceeds with the machine learning model predicting a part of the text data by itself. In the present embodiment, the dialogue system of the text generation model is used to perform the estimation in the following procedure. First of all, the OCR result (character string, coordinate, and the like) of the entire scanned image, the character string corresponding to the desired item, and the statement to instruct the estimation of the item attribute are inputted to the text generation model. Thus, inside the text generation model, natural language processing based on the inputted information is performed to estimate the item attribute of the character string corresponding to the desired item. Note that, in a case of using the Transformer model as a multimodal AI that can also perform image input, the input to the model may be the scanned image data before the OCR is performed.

### <Estimation of Item Attribute>

A specific example of the estimation of the item attribute using the text generation model according to the present embodiment is described with reference to FIG. 7 described above. First of all, the scanned image illustrated in FIG. 7, a coordinate [2102,520,103,64] of the text block “1001” on the right of “bill No.:,” and the statement (prompt) instructing the estimation of the item attribute are inputted to the text generation model. The statement in this case is, for example, “Please estimate the item attribute of the character string in the inputted text block and output in a JSON format. Please output the item attribute by a word.” In a case of this statement, the estimation result structured in the JSON format is obtained for the character string of the designated text block. Specifically, an output in the format of {“character string area”: [2102,520,103,64], “character string”: “1001,” “item attribute”: “billing number”} is obtained. Thus, the item attribute <billing number> is obtained as the estimation result corresponding to the character string “1001.” Additionally, it is possible to estimate also the certainty of the estimation result (in the following, called “item attribute certainty”) by adding the instruction like “Please also output whether the estimation result has ‘high,’ ‘medium,’ or ‘low’ certainty.” to the statement. Thus, in a case where the multiple same item attributes are estimated from the scanned image as the processing target, it is possible to select one item attribute with higher reliability based on the item attribute certainty. Note that, the above-described statement is an example, and it is desirable to input the statement that corresponds to the characteristics of the text generation model. Additionally, the output format and the like may be instructed as default setting. As above, the target item information is obtained based on the item attribute estimated by using the text generation model.

### <Idx Character String Extraction Processing>

In a case where the target item information is obtained by the estimation using the text generation model in S505 as described above, in S506 in the present embodiment, the estimation of the corresponding item attribute based on the result of the whole-area OCR is performed by using the text generation model. In this case, not only each recognized character string but also the information of the corresponding text block may be inputted to the text generation model. In addition, in the subsequent S507, the extraction of the idx character string is performed for the extraction target item by using the text generation model similarly. The extraction in this case is to find the item attribute that matches the item attribute indicated by the target item information from all the “corresponding item attributes” estimated in S506.

Since the item attribute as the estimation target in the present embodiment is not predefined, there is a possibility that inconsistent notation occurs in the target item information obtained in S505 and the estimation result (estimated item attribute) obtained in S506. As an example of the inconsistent notation, <billing number> and <bill number>, <distributing company name> and <billing company name>, and the like may be considered. As a countermeasure for the above-described inconsistent notation, the target item information obtained in S505, a list of the estimated item attribute obtained in S506, and the extraction statement are inputted to the text generation model. A specific example of each of the inputted information is as follows.

### List of Estimated Item Attributes:

[{“character string”: “1001,” “item attribute”: “bill number”}, {“character string”: “bill,” “item attribute”: “title”}, (abbreviated)]

### Target Item Information (Extraction Target Item Attribute):

<billing number>

### Extraction Statement:

“Please extract an element corresponding to the extraction target item attribute from the list of the estimated item attributes and output in the same list format.”

In a case where the above-described information is inputted, [“character string”: “1001,” “item attribute”: “billing number”}] is obtained as an output of the extraction result. In this extraction result, the inconsistent notation between <billing number> and <bill number> is absorbed. Thus, even in a case where the notation of the item attributes do not completely match, it is possible to extract the idx character string of the item attribute indicated by the target item information. This is because the text generation model is learned by using a great amount of text data including context and expresses a word as a feature vector, and thus it is possible to understand a word that has various wording with similar feature vectors as a word having a similar meaning.

As described above, according to the present embodiment, the item attribute is estimated by the text generation model without defining the item attribute in advance. Thus, comparing with the embodiment 1, it is possible to reduce a scene in which no idx character string is extracted, and it is possible to reduce the effort of the user to manually designate the text block in a case of setting the property information, for example.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, it is possible to easily generate property information using a character string corresponding to a desired item in a document.

This application claims the benefit of Japanese Patent Application No. 2025-012768, filed Jan. 29, 2025, which is hereby incorporated by reference herein in its entirety.

What is claimed is:

1. An information processing apparatus configured to generate property information of a scanned image of a document, the information processing apparatus comprising:
at least one memory that stores a program; and
at least one processor that executes the program to perform:
obtaining a first scanned image corresponding to a first document on which filing is to be performed and a second scanned image corresponding to a second document on which filing is already performed;
obtaining property information of the second scanned image that is generated by using a character string corresponding to a predetermined item of the second document; and
generating property information of the first scanned image by using a character string extracted from the first scanned image based on a information indicating an attribute of the predetermined item, wherein
the information indicating the attribute of the predetermined item is information obtained by estimation processing based on the second scanned image and a character string included in the property information of the second scanned image.

2. The information processing apparatus according to claim 1, wherein
in the estimation processing, a predefined item attribute corresponding to the character string included in the property information of the second scanned image is estimated.

3. The information processing apparatus according to claim 2, wherein
the predefined item attribute includes an abstract item attribute independent of a document type and a detailed item attribute obtained by materializing the abstract item attribute according to the document type.

4. The information processing apparatus according to claim 3, wherein
in a case where the item attribute estimated by the estimation processing is not the detailed item attribute,
another second scanned image corresponding to another second document is obtained,
property information of the other second scanned image that is generated by using a character string corresponding to a predetermined item of the other second document is obtained, and
estimation of an item attribute corresponding to a character string included in the property information of the other second scanned image is performed.

5. The information processing apparatus according to claim 1, wherein
the at least one processor that executes the program to further perform the estimation processing.

6. The information processing apparatus according to claim 5, wherein
a rule-based method or a machine learning model is used for the estimation processing.

7. The information processing apparatus according to claim 1, wherein
the property information of the second scanned image is a file name of the second scanned image including the character string corresponding to the predetermined item of the second document or another file including the character string corresponding to the predetermined item of the second document.

8. The information processing apparatus according to claim 1, wherein
as the property information of the first scanned image, a file name of the first scanned image including a character string corresponding to a predetermined item of the first document or another file including the character string corresponding to the predetermined item of the first document is generated.

9. An information processing method for generating property information of a scanned image of a document, the information processing method comprising:
obtaining a first scanned image corresponding to a first document on which filing is to be performed and a second scanned image corresponding to a second document on which filing is already performed;
obtaining property information of the second scanned image that is generated by using a character string corresponding to a predetermined item of the second document; and
generating property information of the first scanned image by using a character string extracted from the first scanned image based on information indicating an attribute of the predetermined item, wherein
the information indicating the attribute of the predetermined item is information obtained by estimation processing based on the second scanned image and a character string included in the property information of the second scanned image.

10. A non-transitory computer readable storage medium storing a instructions to execute an information processing method to generate property information of a scanned image of a document, the information processing method comprising:
obtaining a first scanned image corresponding to a first document on which filing is to be performed and a second scanned image corresponding to a second document on which filing is already performed;
obtaining property information of the second scanned image that is generated by using a character string corresponding to a predetermined item of the second document; and
generating property information of the first scanned image by using a character string extracted from the first scanned image based on information indicating an attribute of the predetermined item, wherein
the information indicating the attribute of the predetermined item is information obtained by estimation processing based on the second scanned image and a character string included in the property information of the second scanned image.
